(19) United States
(12) Patent Application Publication
(10) Pub. No.: US 2012/0042329 A1
(43) Pub. Date: Feb. 16, 2012

(54) JAM-PROOF DEVICE OF SLOT-IN OPTICAL DISK DRIVE

(75) Inventors: Yao-Ching Tsai, Guishan Shiang (TW); Jen-Chen Wu, Guishan Shiang (TW)

(73) Assignee: QUANTA STORAGE INC., Guishan Shiang (TW)

(21) Appl. No.: 13/279,863

(22) Filed: Oct. 24, 2011

Related U.S. Application Data
(63) Continuation-in-part of application No. 12/727,427, filed on Mar. 19, 2010.

(30) Foreign Application Priority Data
May 4, 2009 (TW) 098114884

(51) Int. Cl. G11B 17/051

(52) U.S. Cl. 720/623; 720/622; G9B/17.032

(57) ABSTRACT

The invention provides a jam-proof device of a slot-in optical disk drive. In the jam-proof device, a contact pin protrudes from one end of the loading bar, the other end of the loading bar is pivoted with a pivot on a first side of the casing, and a block protrudes adjacent to the pivot. One end of the unloading bar is pivoted on a second side of the casing opposite to the first side, and a reception end is formed at the other end of the unloading bar to extend to a center of the casing. A distance between the block and the reception end at a default position is shorter than a diameter of an 8-cm disc to prevent the disc from entering the slot-in optical disk drive.

### CROSS REFERENCE TO RELATED PATENT APPLICATION

This patent application is a continuation-in-part (CIP) application of a U.S. patent application Ser. No. 12/727,427 filed Mar. 19, 2010, listing Yao-Ching Tsai and Jen-Chen Wu as inventors. The contents of the related patent application are incorporated herein for reference.

### FIELD OF THE INVENTION

The present invention relates to a slot-in optical disk drive, and particularly to a jam-proof device of a slot-in optical disk drive to prevent a small-sized 8-cm optical disc from entering and causing jam in the slot-in optical disk drive.

### BACKGROUND

Typically, optical discs for data storage are categorized in accordance with the diameters of the discs, including the large-sized 12-cm optical discs and the small-sized 8-cm optical discs. The 8-cm optical disc is easy to carry due to its size, but the 12-cm optical disc has a large data storage amount and is the main stream of optical storage in the current market. To reduce complexity and cost of the mechanism, a slot-in optical disk drive is generally compatible to the 12-cm optical discs, and utilizes signs of warning or blocking mechanisms to prevent the 8-cm optical discs from entering and causing jam in the slot-in optical disk drive.

FIG. 1 shows an example of a slot-in optical disk drive 10, which appears in the Taiwan Patent Publication No. 200805260 as a related art. The slot-in optical disk drive 10 has a traverse 11 in a hollow casing, and the traverse 11 has a spindle motor 12 substantially positioned at the center of the slot-in optical disk drive 10. A block 14 protrudes inwardly from one side of the casing 13 of the slot-in optical disk drive 10 and opposite to an unloading bar 15 on the other side of the casing 13, with the spindle motor 12 positioned between the block 14 and the unloading bar 15. The unloading bar 15 extends toward one end of the spindle motor 12, and a distance between the unloading bar 15 and the block 14 is shorter than the diameter of the 8-cm optical disc 16 to prevent the 8-cm optical disc 16 from entering the slot-in optical disk drive 10 in a deviated way.

Normally, a front edge of the 8-cm optical disc 16 inserted in the slot-in optical disk drive 10 pushes the unloading bar 15 backwards but can not reach an activation switch (not shown). Thus, even though the 8-cm optical disc 16 is forced to enter the slot-in optical disk drive 10, the unloading bar 15 moves back to the default position and pushes the released 8-cm optical disc 16 out so that no jam occurs. However, when the 8-cm optical disc 16 inserted in the slot-in optical disk drive 10 in a deviated way, the unloading bar 15 and the block 14 stops the 8-cm optical disc 16 at a position near the center of the slot-in optical disk drive 10. Thus, when the 8-cm optical disc 16 is pushed back, only a little portion of the 8-cm optical disc 16 is exposed for a user to pull it out from the slot-in optical disk drive 10. If the 8-cm optical disc 16 is forcibly inserted deep into the slot-in optical disk drive 10, the 8-cm optical disc 16 may be jammed in and require tools to be removed from the slot-in optical disk drive 10, thus creating inconvenience and the risk of damaging the optical disc. Accordingly, to increase the exposed portion of the 8-cm optical disc 16 when it is pushed back for easier removal of the jammed disc, a design to move the block 14 to the front end of the slot-in optical disk drive 10 or to increase the horizontal protrusion height h of the block 14 toward the spindle motor 12 is desired.

However, a loading bar 17 is disposed at the front of the block 14, and moving the block 14 to the front end of the slot-in optical disk drive 10 may affect rotation of the loading bar 17, thus restricting the position that the block 14 can be moved forward to. On the other hand, the increases of the horizontal protrusion height h of the block 14 may block the 12-cm optical disc 18 to enter the passage of the slot-in optical disk drive 10, thus creating a problem that the 12-cm optical disc 18 has a difficulty to enter or exit from the slot-in optical disk drive 10. With all these limitations, the block 14 can not fully prevent the 8-cm optical disc 16 from entering the slot-in optical disk drive 10. Hence there is a problem to be solved in the slot-in optical disk drive to prevent from jam of the 8-cm optical discs.

### SUMMARY OF THE INVENTION

An objective of the present invention is to provide a jam-proof device of a slot-in optical disk drive to increase the exposed portion of the 8-cm optical disc when it is pushed back for easier removal of the jammed disc by providing a block on the loading bar.

A further objective of the present invention is to provide a jam-proof device of a slot-in optical disk drive to provide a block on the loading bar which rotates to form a position-variable block according to the angle of the loading bar. In this way, the position-variable block protrudes and forms a block for blocking the 8-cm optical disc and moves to give way to enable entering of the 12-cm optical disc.

A further objective of the present invention is to provide a jam-proof device of a slot-in optical disk drive to form the block integrally on the loading bar so that the assembly and manufacturing cost is reduced.

In order to achieve the foregoing objectives of the invention, in a jam-proof device of a slot-in optical disk drive of the invention, a contact pin protrudes from one end of the loading bar, the other end of the loading bar is pivoted with a pivot on a first side of the casing, and a block protrudes adjacent to the pivot. One end of the unloading bar is pivoted on a second side of the casing opposite to the first side, and a reception end is formed at the other end of the unloading bar to extend to a center of the casing. A distance between the block and the reception end at a default position is shorter than a diameter of an 8-cm disc.

In an embodiment of the present invention, the pivot can be positioned between the contact pin and the block, and the block can be a position-variable block moving away from or close to the first side of the casing in response to rotation of the loading bar. The distance between the position-variable block and the reception end at the default position can be maintained shorter than the diameter of the 8-cm disc when the position-variable block is moving. Thus, the position-variable block prevents the 8-cm optical disc from entering the slot-in optical disk drive and moves to give way to enable entering of the 12-cm optical disc.

In the jam-proof device of the slot-in optical disk drive of the invention, the block can formed integrally on the loading bar. The block can also be positioned at the pivot or adjacent to the first side of the casing, so that the block is movably positioned toward the front end of the slot-in optical disk drive to increase the exposed portion of the 8-cm optical disc when it is pushed back for easier removal of the jammed disc.

### BRIEF DESCRIPTION OF THE DRAWINGS

FIG. 1 is an upper view of a slot-in optical disk drive in the related art;

FIG. 2 is a perspective view of a slot-in optical disk drive according to an embodiment of the invention;

FIG. 3 is an enlarged view of part A in FIG. 2;

FIG. 4 is a schematic view showing position change of the position-variable block according to an embodiment of the invention;

FIG. 5 is an upper view of a slot-in optical disk drive with an 8-cm optical disc inserted therein according to the embodiment of the invention;

FIG. 6 is an upper view of a slot-in optical disk drive with a 12-cm optical disc inserted therein according to the embodiment of the invention; and

FIG. 7 is a partially enlarged view of a jam-proof device of a slot-in optical disk drive according to another embodiment of the invention.

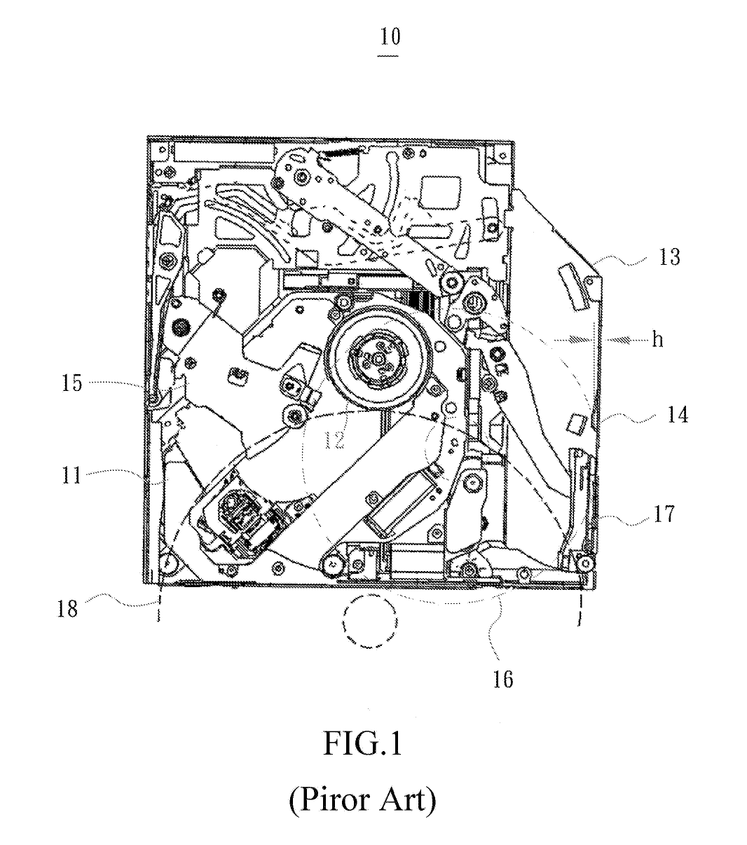

### DETAILED DESCRIPTION OF THE INVENTION

The techniques employed by the present invention to achieve the foregoing objectives and the effects thereof are described hereinafter by way of examples with reference to the accompanying drawings.

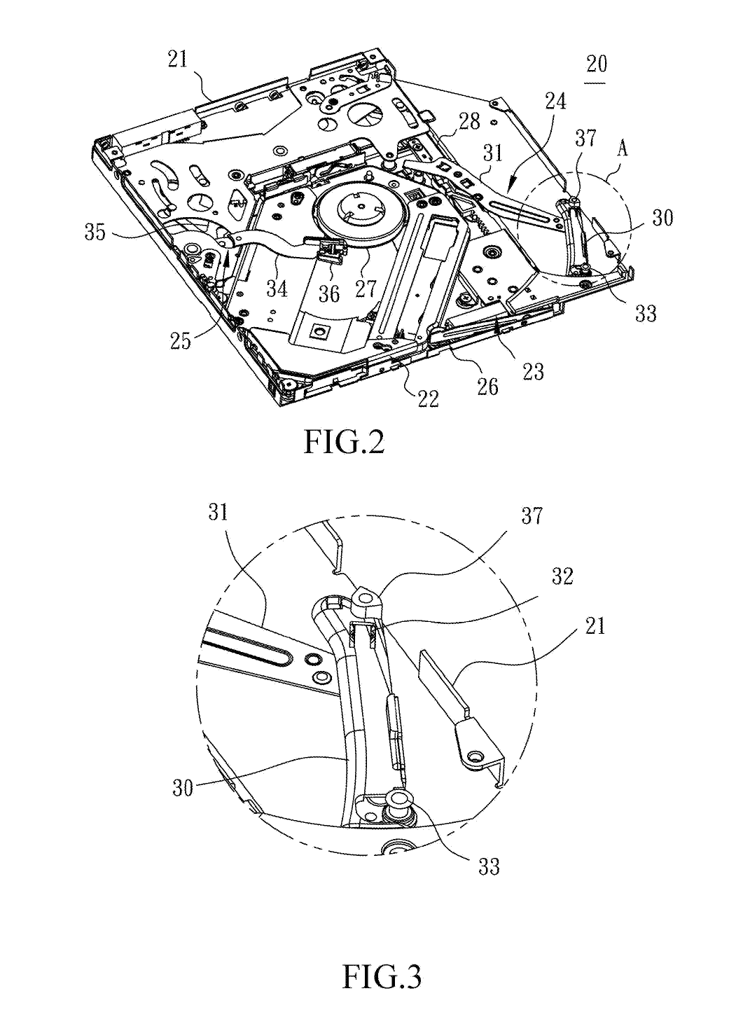

Referring to FIG. 2 and FIG. 3, FIG. 2 shows a slot-in optical disk drive 20 according to an embodiment of the invention, and FIG. 3 shows an enlarged view of part A in FIG. 2. The slot-in optical disk drive 20 has a casing 21, a traverse 22, a power unit 23, a loading mechanism 24 and an unloading mechanism 25. The casing 21 is hollow and has an opening 26 at the front end. The traverse 22 is disposed in the casing 21, with its one end pivoted on one side of the casing 21 and the other end provided with a spindle motor 27 and extending toward the center of the casing 21. The power unit 23 is disposed in the casing 21 adjacent to the traverse 22 to drive a sliding element 28 to move along the side of the casing 21 and to supply the power for the slot-in optical disk drive 20.

The loading mechanism 24 has a loading bar 30 and a driving bar 31. The loading bar 30 has two ends. One end of the loading bar 30 is pivoted with a pivot 32 on the side (a first side) of the casing near the opening 26. A contact pin 33 protrudes from the other end of the loading bar 30 and extends toward the opening 26 in an original position. The driving bar 31 is driven by the sliding element 28 and connects to the loading bar 30 to drive the loading bar 30 to rotate in an angle to push the optical disc into the optical disk drive. The unloading mechanism 25 has an unloading bar 34 and a linkage bar set 35. The unloading bar 34 has two ends. One end of the unloading bar 34 is pivoted on a second side of the casing 21 opposite to the loading bar 30 (the first side), and a reception end 36 is formed at the other end of the unloading bar 34 to extend to the spindle motor 27 at the center of the casing 21 in a default position. The linkage bar set 35 is driven by the sliding element 28 and connects to the unloading bar 34 to drive the unloading bar 34 to rotate in an angle to push the optical disc out from the optical disk drive. The technology to utilize the power unit 23 to drive the loading bar 30 and the unloading bar 34 to rotate and push the optical disc into or out from the optical disk drive is well-known and therefore not described hereinafter in detail.

In the loading bar 30 and the unloading bar 34 of the jam-proof device of the embodiment, a block 37 protrudes upward at the end of the pivot 32 of the loading bar 30. The block 37 is on the back side and adjacent to the pivot 32, and the pivot 32 is positioned between the contact pin 33 and the block 37. The block 37 can protrude by connection or integrally from the loading bar 30. The block 37 can be a position-variable block moving away from or close to the first side of the casing 21 in response to rotation of the loading bar 30. When the position-variable block 37 is moving, the distance between the position-variable block 37 and the reception end 36 of the unloading bar 34 at the default position is maintained shorter than the diameter of the 8-cm disc. The position-variable block 37 allows a 12-cm disc to enter and exit the slot-in optical disk drive 20 in a process of moving toward or away from the first side of the casing 21.

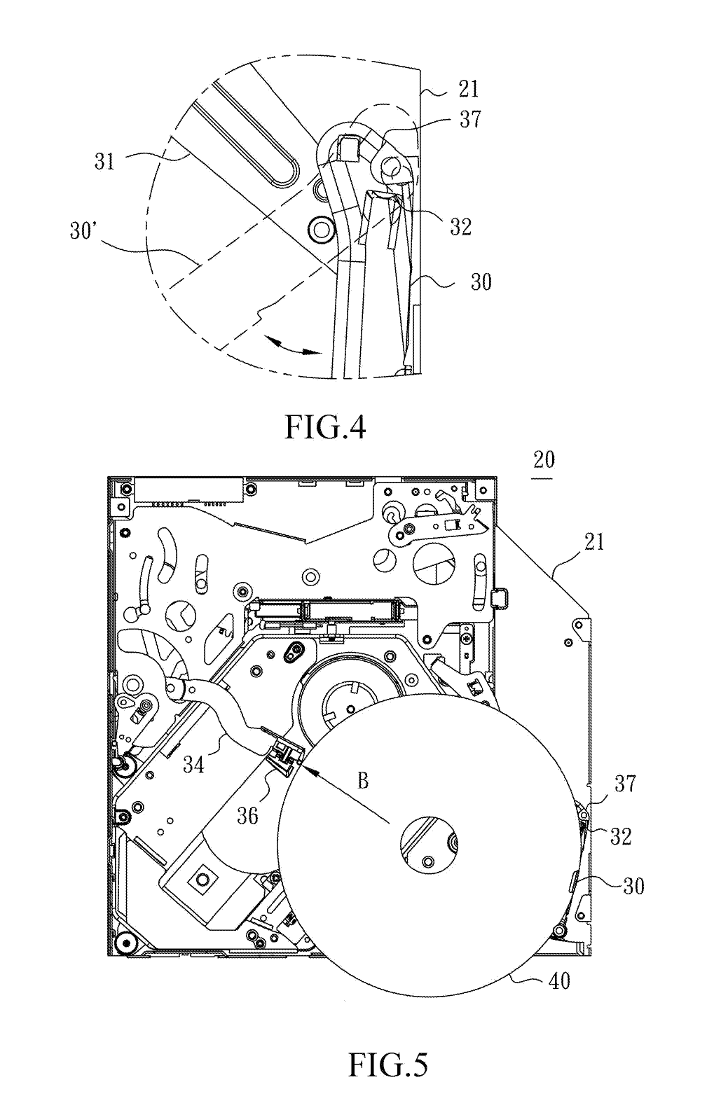

FIG. 4 is a schematic view showing the position change of the position-variable block 37. The driving bar 31 drives the loading bar 30 to rotate so that the loading bar 30 rotates around the pivot 32 for an angle from the original position 30′, shown in dotted line, to the position of the loading bar 30 shown in solid line. At the same time, the block 37 at the back side of the pivot 32 moves around the pivot 32 accordingly. When the loading bar 30 moves to the original position 30′ near the opening, the block 37 moves toward the first side of the casing 21; and when the loading bar 30 moves toward the first side of the casing 21, the block 37 moves away from the first side of the casing 21.

Referring to FIG. 4 and FIG. 5, where FIG. 5 shows a slot-in optical disk drive 20 with a 8-cm optical disc 40 inserted in a deviated way therein. When the 8-cm optical disc 40 is inserted into the slot-in optical disk drive 20, the edge of the 8-cm optical disc 40 faces and rebuts the reception end 36 at one end of the unloading bar 34, as shown in the arrow B. Thus, the unloading bar 34 is unable to rotate, and the loading bar 30 rotates around the pivot 32 to turn toward the first side of the casing 21 to make the block 37 on the other side of the pivot 32 to move away from the first side of the casing 21 and toward the reception end 36 of the unloading bar 34. Accordingly, the distance therebetween is shortened to prevent the 8-cm optical disc 40 from entering the slot-in optical disk drive 20. The block 37 moves forward to the loading bar 30 so that the 8-cm optical disc 40 is unable to move deep into the slot-in optical disk drive 20, thus exposing a portion of the 8-cm optical disc 40 for easier removal of the jammed disc.

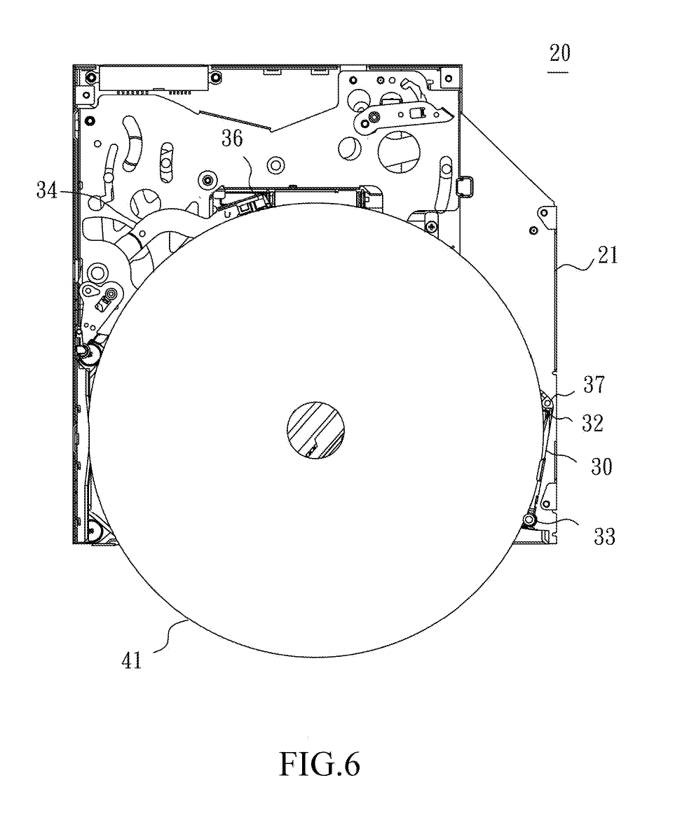

Referring to FIG. 4 and FIG. 6, where FIG. 6 shows a slot-in optical disk drive 20 with a 12-cm optical disc 41 inserted therein. When the 12-cm optical disc 41 is inserted into the slot-in optical disk drive 20, the edge of the 12-cm optical disc 41 rebuts one side of the slot-in optical disk drive 20, and the other side pushes the loading bar 30 to rotate around the pivot 32 and turn toward the first side of the casing 21 to make the block 37 on the other side of the pivot 32 to move away from the first side of the casing 21 and toward the reception end 36 of the unloading bar 34. Accordingly, the distance therebetween is shortened but does not jam the front edge of the 12-cm optical disc 41. The front edge of the 12-cm optical disc 41 pushes the reception end 36 of the unloading bar 34 to rotate the unloading bar 34 so that the 12-cm optical disc 41 can keep entering the slot-in optical disk drive 20. When the contact pin 33 of the loading bar 30 passes the middle point of the 12-cm optical disc 41, it moves away from the side of the casing 21 along the back edge of the 12-cm optical disc 41 and forces the block 37 moves toward the side of the casing 21 and away from the passage of the 12-cm optical disc 41. In this way, the 12-cm optical disc 41 can keep moving into the slot-in optical disk drive 20 without creating a jam.

Accordingly, by providing a block on the rotating loading bar, the jam-proof device of the slot-in optical disk drive allows the block to move forward to the front side of the optical disk drive and forms a position-variable block according to the rotation of the loading bar. The position change of the block allows increase of the exposed portion of the 8-cm optical disc for easier removal of the jammed disc. Also, by forming the block all-in-one on the loading bar, the assembly and manufacturing cost is reduced.

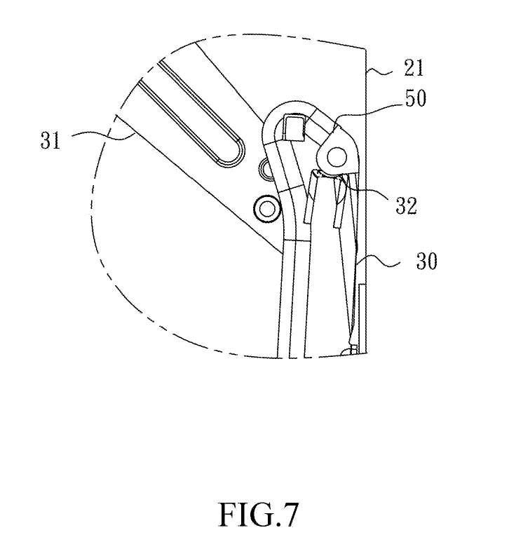

FIG. 7 shows another embodiment of the jam-proof device of the slot-in optical disk drive. The basic mechanism of the slot-in optical disk drive in this embodiment is substantially similar to the previous embodiment, and the elements of the same structure utilize the same numeral in the drawings. The distinction between the embodiments is that the block 50 in this embodiment is moved forward and disposed on the loading bar 30 to be positioned at the pivot 32 or adjacent to the first side of the casing 21 so that the block 50 moves along with the rotation of the loading bar 30 and does not protrude to block the passage of the 12-cm optical disc. The distance between the block 50 and the reception end at a default position is maintained shorter than a diameter of an 8-cm disc. Thus, the block can increase the exposed portion of the 8-cm optical disc for easier removal of the jammed disc.

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A jam-proof device of a slot-in optical disk drive disposed in a casing of the slot-in optical disk drive, the jam-proof device comprising:
a loading bar having two ends, wherein a contact pin protrudes from one end of the loading bar, the other end of the loading bar is pivoted with a pivot on a first side of the casing, and a block protrudes adjacent to the pivot; and
an unloading bar having two ends, wherein one end of the unloading bar is pivoted on a second side of the casing opposite to the first side, and a reception end is formed at the other end of the unloading bar to extend to a center of the casing;
wherein a distance between the block and the reception end at a default position is shorter than a diameter of an 8-cm disc.

2. A jam-proof device of a slot-in optical disk drive according to claim 1, wherein the block is formed integrally on the loading bar.

3. A jam-proof device of a slot-in optical disk drive according to claim 1, wherein the pivot is positioned between the contact pin and the block.

4. A jam-proof device of a slot-in optical disk drive according to claim 3, wherein the block is a position-variable block moving away from or close to the first side of the casing in response to rotation of the loading bar.

5. A jam-proof device of a slot-in optical disk drive according to claim 4, wherein the distance between the position-variable block and the reception end at the default position is maintained shorter than the diameter of the 8-cm disc when the position-variable block is moving.

6. A jam-proof device of a slot-in optical disk drive according to claim 4, wherein the position-variable block moves toward the first side of the casing when the one end of the loading bar with the contact pin tilts, and the position-variable block moves away from the first side of the casing when the loading bar moves toward the first side of the casing.

7. A jam-proof device of a slot-in optical disk drive according to claim 4, wherein the position-variable block allows a 12-cm disc to enter and exit the slot-in optical disk drive in a process of moving toward or away from the first side of the casing.

8. A jam-proof device of a slot-in optical disk drive according to claim 1, wherein the block is positioned at the pivot.

9. A jam-proof device of a slot-in optical disk drive according to claim 1, wherein the block is positioned at the pivot adjacent to the first side of the casing.
